(19) United States
(12) Patent Application Publication
(10) Pub. No.: US 2005/0132194 A1
(43) Pub. Date: Jun. 16, 2005

(54) Protection of identification documents using open cryptography

(76) Inventor: Jean Renard Ward, Arlington, MA (US)

Correspondence Address: DIGIMARC CORPORATION, 9405 SW GEMINI DRIVE, BEAVERTON, OR, 97008, US

(21) Appl. No.: 10/734,614

(22) Filed: Dec. 12, 2003

(51) Int. Cl. H04L 9/00

(52) U.S. Cl. 713/176

(57) ABSTRACT

The present invention provides methods and apparatus to uniquely determine fabrication details associated with objects, such as identification documents, artwork and limited issue works, using open cryptographic techniques. A cryptographic signature is created using a private key. The private key is uniquely associated with fabrication details such as a workstation, operator, fabrication equipment, fabrication materials, etc. A public key corresponds with the private key; and therefore, the public key is associated with the fabrication details. Successfully decoding the cryptographic signature with the public key uniquely identifies the fabrication details.

### FIELD OF THE INVENTION

The present invention relates generally to identification documents and other fabricated items that include identifying information. In a first embodiment, fabrication details of an identification documents are determined using open cryptographic measures.

### BACKGROUND AND SUMMARY OF THE INVENTION

Introduction

The present invention provides apparatus and methods for identifying fabrication details that are associated with objects like identification documents. A cryptographic measure is included in a print structure that is carried by an identification document. The cryptographic measure provides a forensic tracking tool—to allow the document to be traced back through a chain of events that led to its creation and/or distribution. The cryptographic measure also provides an alteration detection mechanism, and allows for the detection of unauthorized issuance. The term “unauthorized issuance” is intended to include documents produced on authorized equipment (e.g., at an authorized Department of Motor Vehicles (“DMV”) issuing station), but produced in an unauthorized manner. For example, an unscrupulous employee may generate so-called “off-the-book” documents for unofficial issuance.

Identification Documents

For the purposes of this disclosure, identification documents are broadly defined and may include, e.g., credit cards, bank cards, phone cards, passports, driver's licenses, access cards, employee badges, debit cards, security cards, visas, immigration documentation, national ID cards, citizenship cards, social security cards, security badges, certificates, identification cards or documents, voter registration cards, police ID cards, border crossing cards, legal instruments or documentation, security clearance badges and cards, gun permits, gift certificates or cards, documents which identify objects (e.g., such as auto registrations), manufacturer's labels, labels, membership cards or badges, etc., etc. The terms “document,” “card,” and “documentation” are used interchangeably throughout this patent document. Identification documents are also sometimes referred to as “ID documents.”

Identification documents can include information such as a photographic image, a bar code (e.g., which may contain information specific to a person whose image appears in the photographic image, and/or information that is the same from ID document to ID document), variable personal information (e.g., such as an address, signature, and/or birth date, biometric information associated with the person whose image appears in the photographic image, e.g., a fingerprint), a magnetic stripe (which, for example, can be on a side of the ID document that is opposite a side with a photographic image), and various designs (e.g., a security pattern like a printed pattern comprising a tightly printed pattern of finely divided printed and unprinted areas in close proximity to each other, such as a fine-line printed security pattern as is used in the printing of banknote paper, stock certificates, and the like). Of course, an identification document can include more or less of these types of features.

One exemplary ID document comprises a core layer (which can be pre-printed), such as a light-colored, opaque material, e.g., TESLIN, which is available from PPG Industries) or polyvinyl chloride (PVC) material. The core can be laminated with a transparent material, such as clear PVC to form a so-called “card blank”. Information, such as variable personal information (e.g., photographic information, address, name, document number, etc.), is printed on the card blank using a method such as Dye Diffusion Thermal Transfer (“D2T2”) printing (e.g., as described in commonly assigned U.S. Pat. No. 6,066,594, which is herein incorporated by reference), laser or inkjet printing, offset printing, etc. The information can, for example, comprise an indicium or indicia, such as the invariant or nonvarying information common to a large number of identification documents, for example the name and logo of the organization issuing the documents. Indicia is also used in this document to refer to plain text and machine-readable features.

To protect information printed on a document surface, an additional layer of transparent overlaminate is preferably coupled to the printed document surface. Illustrative examples of usable materials for overlaminates include biaxially oriented polyester or other optically clear durable plastic film.

One type of identification document 100 is illustrated with reference to FIG. 1. The identification document can include a substrate/core 120 with a protective or decorative overlaminate 112 or 112′. The identification document 100 optionally includes a variety of features like a photograph 104, ghost or faint image 106, signature 108, fixed information 110 (e.g., information which is generally the same from ID document to ID document), other machine-readable information (e.g., bar codes, 2D bar codes, data glyphs, other 2D symbologies, optical memory) 114, variable information (e.g., information which generally varies from document to document, like bearer's name, address, document number) 116, etc. The document 100 may also include overprinting (e.g., DOB over image 106), digital watermarking (e.g., embedded in photograph 104 and/or in ghost or faint image 106), graphics, artwork and/or microprinting (items not shown).

Of course, there are many other physical structures/materials, feature placement, and alternative features and feature combinations that can be suitably interchanged for use with the techniques described herein. The inventive techniques disclosed in this patent document will similarly benefit these other documents as well. For example, an ID document (e.g., a label) may be attached to a manufactured article. The ID document then preferably includes identifying information which may be printed, embossed, stamped, or otherwise included or associated with the manufactured article, which may identify one or more of a model name, a serial number, lot number, manufacturer, manufacturing equipment, factory of production, etc.

Types of ID Document Production

Commercial systems for issuing ID documents include two main types, namely so-called “central” issue (CI), and so-called “on-the-spot” or “over-the-counter” (OTC) issue.

CI type ID documents are not immediately provided to a document bearer, but are later issued to the bearer from a central location. For example, in one type of CI environment, a bearer reports to a document station where data is collected, the data is forwarded to a central location where the card is produced, and the card is forwarded to the bearer, often by mail. Another illustrative example of a CI assembling process occurs in a setting where a driver passes a driving test, but then receives her license in the mail from a CI facility a short time later. Still another illustrative example of a CI assembling process occurs in a setting where a driver renews her license by mail or over the Internet, then receives a drivers license card through the mail.

Centrally issued identification documents can be produced from digitally stored information and generally comprise an opaque core material (also referred to as “substrate”), such as paper, synthetic or plastic, sandwiched between two layers of clear plastic laminate, such as polyester, to protect the aforementioned items of information from wear, exposure to the elements and tampering. The materials used in such CI identification documents can offer the ultimate in durability. In addition, centrally issued digital identification documents generally offer a higher level of security than OTC identification documents because they offer the ability to pre-print the core of the central issue document with security features such as “micro-printing”, ultra-violet security features, security indicia and other features currently unique to centrally issued identification documents. Another security advantage with centrally issued documents is that the security features and/or secured materials used to make those features are centrally located, reducing the chances of loss or theft (as compared to having secured materials dispersed over a wide number of OTC locations).

In addition, a CI assembling process can be more of a bulk process facility, in which many cards are produced in a centralized facility, one after another—leveraging economies of scale. The CI facility may, for example, process thousands of cards in a continuous manner. Because the processing occurs in bulk, CI can have an increase in efficiency as compared to some OTC processes, especially those OTC processes that run intermittently. Thus, CI processes can sometimes have a lower cost per ID document, if a large volume of ID documents is manufactured.

In contrast to CI identification documents, OTC identification documents are issued immediately to a bearer who is present at a document-issuing station. An OTC assembling process provides an ID document “on-the-spot”. An illustrative example of an OTC assembling process is a Department of Motor Vehicles (“DMV”) setting where a diver's license is issued to a person, on the spot, after a successful exam. In some instances, the very nature of the OTC assembling process results in small, sometimes compact, printing and card assemblers for printing the ID document.

Security Features and Concerns

It is desirable to address three general identification document security concerns that involve detection of:
forgery of a document;
alteration of the document; and
issuance of a document without authorization.

These problems are particularly acute when an identification document is inspected in the field (such as inspection by a police officer), where:
time is short, e.g., there may be only a few seconds to examine the document;
access to bulky or expensive special equipment is difficult; and
contact back to a central authority or office may not be possible.

Designers of identity documents have traditionally added features, many public but especially many that are less public, to make it more probably that forged documents can be detected. Some such features include:
constructing documents using special materials that may be difficult for a forger to obtain (optical laminates, security threads, etc.);
constructing documents using special fabrication processes with detectable effects, where the processes may be difficult for a forger to duplicate or simulate (e.g., traditional watermarks, micro-printing, fine line structures, special colors, etc.);
including intentional “hidden defects” that a forger may overlook, but which a careful detailed examination can reveal (easily overlooked miss-spellings (e.g. ‘5” for “S’) in small print, use of a different font for certain characters in a larger block of text); and
including secret patterns or printing that can only be seen with special equipment (fluorescent inks, moiré patterns).
   These techniques are intended to make passable forgeries more difficult to produce.

Some techniques used to make document alteration more readily detectible include:
use of a fabrication process and material where an alteration becomes apparent as a “forgery” (e.g., text is printed under a security laminate so that alteration of the text requires the laminate to be visibly damaged, etc.);
inclusion of a “checksum” for text data (or digital watermark for image data), which make alterations of the data apparent unless the checksum is changed to match; and
incorporating a second “secret” copy of the data elsewhere on the document, so that altered data can be compared against the “secret” copy.

An emerging problem is “unauthorized issuance” of identity documents. Unauthorized issuance involves documents that may be produced to be mechanically identical or sufficiently similar to authorized documents, so as to complicate forgery detection.
A simple and likely source of an authorized document is a worker who produces authentic documents, but the worker's integrity becomes compromised such that he produces unauthorized documents on real equipment;
Another likely source is equipment that is taken out of service and re-sold, or transferred to a different office for the creating of different classes of IDs, that use the same fabrication process; and
Still another source is a central set of records. For example, if there is complete reliability on reference to a central set of records, the central records constitute an especially attractive “honey pot” for forgers, who may attempt to alter or add to the central records, or may merely copy the identifying information from the central records.

Techniques used to detect “unauthorized issuance” of documents are often restrictive. A conventional technique includes a unique serial number or other text identifier in each ID document. Unauthorized issuance is detectable by comparing the identifier from a document with records in a central issuing office, which exhaustively list all authorized documents.

Given the complexity of security concerns, and the ingenuity of forgers, it is not surprising that the security techniques mentioned above may make successful forgery more difficult, but do not make it impossible. In particular, the techniques described above may be subject to the following attacks, among others:
special materials may be stolen, or another purchaser subverted, thus making it possible to construct a forged document with passable materials;
special materials and fabrication processes may be duplicated closely enough (with sufficient effort) to construct a passable forged document;
“hidden defects” may, over time, become known to forgers, either by examination of legitimate documents, or because the defects have to be known to document identifiers so that they can be checked for, and the information gradually becomes more widely known;
for features that require special equipment to be detected, the equipment may be too expensive to be available in the field in all circumstances;
checksum text necessarily involves a specific checksum calculation: non-cryptographic checksums are subject both to being well-known (only well-examined and well-known algorithms are generally considered reliable), and to being subject to reverse-engineering to determine the calculation used; and
comparison of serial numbers (or an equivalent) with a central set of records may sometimes be unreliable, if it is not possible for field personnel (e.g. in a police car) to have real-time communication with the central records at all times.
   Features and Advantages of the Present Invention

The present invention provides additional security features to address at least some the above fraudulent scenarios. Some aspects of the present invention use cryptographic measures to provide verifiable fabrication details that are associated with identification document fabrication. For example, a cryptographic signature is created using a private key. The private key is uniquely associated with fabrication details such as a workstation, operator, fabrication equipment, fabrication materials, etc. A public key corresponds with the private key; and therefore, the public key is associated with the fabrication details. Successfully decoding the cryptographic signature with the public key uniquely identifies the fabrication details.

Verifying fabrication detail—against predetermined or expected details—can be also used to determine whether to trust an identification document or to detect “unauthorized issuance” of identification documents. These aspects go beyond the conventional identification of a digital signor. Indeed, these inventive aspects allow forensic tracking of fabrication details including identifying fabrication equipment, equipment operators, materials used in the fabrication process and/or fabrication completion date. Other aspects use cryptographic measures to tie one document feature (e.g., a 2D-Bar code or digital watermark) to another document feature (e.g., photograph, 1D-barcode, digital watermark, etc.) or to a document bearer. Of course, a cryptographic measure can be used to verify authenticity of information carried by an identification document.

One aspect of the present invention is an identification document including a photographic representation of a bearer of the identification document and indicia provided on the document. The identification document further includes a security feature printed on a surface of the identification document in a two-dimensional symbology. The security feature includes: a first set of information corresponding to at least one of the identification document, the bearer of the identification document and an issuer of the identification document, wherein the first set of information comprises an unencrypted form; and a cryptographic measure associated with the first set of information. The cryptographic measure identifies at least a record of fabrication for the identification document.

Another aspect of the present invention is a method of analyzing an identification document. The identification document includes a first set of information and a cryptographic signature corresponding to the first set of information. The first set of information and the cryptographic signature are encoded in a machine-readable format. The encoding is printed or engraved on a surface of the identification document. The method includes machine sensing the first set of information and the cryptographic signature; and determining fabrication details of the identification document from at least the cryptographic signature.

In one implementation of this aspect, the machine-readable format includes digital watermarking. In another aspect, the method further comprises determining whether the identification document is suspect based at least on the cryptographic signature. For example, the cryptographic signature may include a date indicator, and the determining step determines whether the date indicator corresponds with an untrusted date. Examples of fabrication details include an identification document distribution record, a type of identification document, document assembler, equipment used in fabrication, a fabrication equipment operator, materials used in fabrication, document lot number and document batch number.

Yet another aspect of the present invention is a method of identifying unauthorized issuance of an identification document. Unauthorized issuance occurs when the identification document is fabricated on authorized equipment, but is issued in an unauthorized manner. The identification document includes first data and a digital signature corresponding to at least the first data. The digital signature further includes a date indicator associated with the fabrication of the identification document. The method includes: i) machine-sensing the identification document to obtain the first data and the digital signature; ii) validating the digital signature in accordance with a certificate associated with the digital signature; iii) determining whether the certificate has been revoked, and if so revoked, iv) determining whether the date indicator corresponds with a date associated with the certificate's revocation, and if so associated, v) identifying the identification document as being issued without authority.

The foregoing and other features, aspects and advantages of the present invention will be even more readily apparent from the following detailed description, which proceeds with reference to the accompanying drawings.

### BRIEF DESCRIPTION OF THE DRAWINGS

FIG. 1 illustrates an identification document.

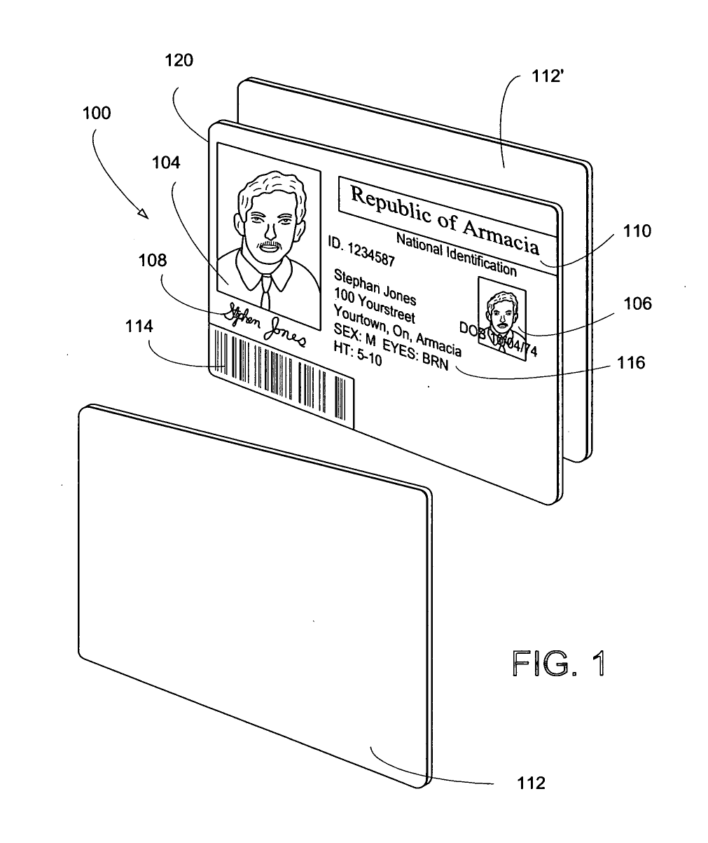

FIGS. 2a and 2b illustrate front and rear views of an identification document including a print structure (rear view) carrying a cryptographic measure.

FIG. 3 illustrates a document fabrication process including creation of a cryptographic measure.

FIG. 4 illustrates a multi-station document production process.

### DETAILED DESCRIPTION

The following description details various embodiments of secure identification document production. This description also details methods to reliably trace and verify fabrication details associated with an identification document.

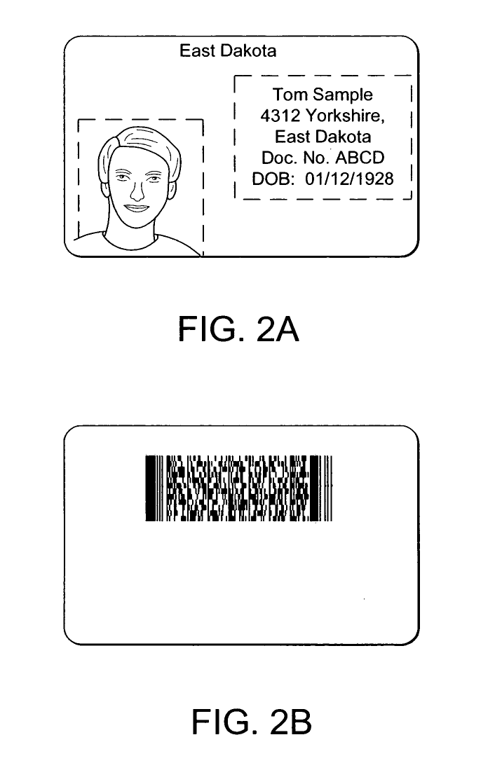

Front and backsides of an identification document are illustrated, respectively, in FIGS. 2a and 2b. The illustrated identification document includes a plurality of features including a photographic representation of an authorized bearer of the document, so-called fixed information (e.g., information that remains the same from document to document, like issuing jurisdiction, seals, graphics, artwork, etc.) and so-called variable information (e.g., information that is unique to the identification document or the bearer of the identification document, like document number, birth date, address, biometric information, etc.). The document preferably includes some clear-text information carried, e.g., by a two-dimensional symbology (e.g., PDF417 or data glyphs), on the identification document. A magnetic stripe (not shown) can also be provided.

The two-dimensional symbology includes data encoded therein. The information can vary according to issuer discretion, and may even be dictated by applicable standards (e.g., as promulgated by the American Association of Motor Vehicles Administrators or “AAMVA”). For simplicity, we present a scenario where the encoded data includes at least four fields, e.g., Issuer (e.g., Oregon or USA), ID Number (e.g., “7319Z245”), Name (e.g., “Joan T. Sample”), and Birth Date (e.g., Dec. 15, 1928), as shown below in Table 1. Of course the fields are typically converted into binary form prior to encoding with the symbology.

TABLE 1
Data Fields

| | | | |
|---|---|---|---|
| Issuer | ID Number | Name | Birth Date |

Table 1 should not be construed as limiting the scope of the present invention, since the inventive techniques can be applied to many other information configurations. Indeed, a two-dimensional symbology will likely carry many additional or alternative data fields And instead of encoding the information in a two-dimensional symbology, the data can be carried by a digital watermark, printed text, etc. Raw data contained in the symbology can be formatted in many different ways. In one implementation fields are designed by a 3 character “designation” (e.g. “DAA” to designate a comma-separated name) immediately followed by the designated information. Another example is “ZNF,” to designate a digital certificate (discussed below). Commas, spacing (including tabs) or semicolons, etc. can be further used to separate data. Thus the tables shown in this document are but one possible data arrangement.

Prior to encoding into the symbology, the data fields are augmented to include a cryptographic measure or an equivalent measure. I prefer Public Key cryptography (commonly referred to as “PKI”) to secure the data and to establish verifiable fabrication details. The terms “PK,” or “asymmetric cryptography,” are often referred to as so-called “PKI,” although the PKI acronym technically refers to non-cryptographic infrastructure—specifically the use of Certifying Authorities, Certificate Status Responders, and the like—used to support many PK applications. This infrastructure is not required by my invention, but for ease of reading, I sometimes use the term PKI to represent cryptographic measures and/or related infrastructure.

Some Encryption Background

A few cryptography details are provided as background for the reader's convenience. Of course, PKI techniques are well known by those of ordinary skill in the cryptography arts; thus, an intensive discussion of PKI need not be belabored herein. Nevertheless, a few details are helpful to provide context for my inventive techniques.

PKI (or “PK”) relies to a pair of complimentary (or asymmetric) keys—one public and the other kept private. The public key is distributed while the private key is held in strict confidence. All PKI functionalities—cryptographic signatures, encryption, decryption, etc.—are built around the separation of the private and the public key. Consider the following examples. Jane encrypts a message for Fred. To do so, Jane encrypts the message using Fred's public key, and thus only Fred can decode it, because only Fred has the matching private key. But if Jane wants to “sign” a message to the public at large, Jane encrypts a hash of the message using her private key (e.g., using SHA-1, MD-5 or other hashing algorithm), and then appends the encrypted hash to the message as a “signature.” Only Jane can create this “signature,” because only she has her private key. Of course, anyone in the world can decode the “signature” using Jane's public key, which verifies that the signature was from Jane. Performing the same hashing function on the message and comparing it to Jane's signature hash additionally verifies message “integrity”. The message is considered suspect if the signature cannot be verified, e.g., when the decrypted hash does not match a recalculated hash of the message. The term “suspect” in this document means untrustworthy or at least suspicious or questionable.

But how does one know that Jane is really Jane? The question can be rephrased in terms of “trust.” How does one trust a signature? In the PKI world, you trust a public key if-and-only-if the key and its owner are certified by a Certificate Authority (CA). A CA is an entity responsible for issuing and administering “certificates.” The CA serves as an agent of trust. Certificates include information to authenticate the identity of a person or entity. The certificate itself is simply a collection of information to which a digital signature is attached. The CA verifies this information so that a community of certificate users can trust a digital signature. As long as users trust the CA and its business processes, they can trust certificates issued by the CA.

A CA creates a certificate for a first party. The certificate includes information to identify the first party, which is often encrypted by the CA's private key. The certificate may also include the first party's public key. The first party creates a message, signs the message with the first party's private key and attaches their certificate. When a second party receives the digitally signed message from the first party, the second party verifies the certificate with the CA's public key. If verified, the second party trusts the certificate as authentic. To verify the signature, the second party uses the first party's public key (obtained, e.g., from the certificate or from the first party) to decrypt and verify the signature.

By way of further example, a certificate may contain the following:
Name/address/identity of a signing party;
The public key for the party;
The name/identity of the CA who created the certificate (e.g., a web URL if the CA has a web-presence);
The date the certificate was issued (and perhaps an expiration date);
A unique serial number for the certificate; and
a signature across some or all the data above, generated using the CA's private key.
   Of course, there are many acceptable certificate formats, e.g., PKIX (X.509), which can be suitably interchanged with the certificate formats discussed herein.

A CA preferably publishes or maintains a “Certificate Revocation List” (CRL), which is a list of serial numbers identifying compromised certificates. For example, a user may report that a private key was stolen (or copied, or lost, etc.) and the last date the lost key was known to be valid. All certificates associated with the lost private key are added to the CRL. Thus, when a receiving party verifies a certificate/signature, the receiving party also checks a CRL list to ensure that the certificate is not listed thereon. If the certificate is on the CRL, and if the digital signature is dated after the date listed in the CRL, then the receiving party should not trust the signature/message. Some CA authorities manage certificates with unique serial numbers. But other standard PKI applications do not use a serial number for a certificate, and instead use a certificate's “fingerprint,” e.g., an MD-5 hash of at least some of the certificate's data, to represent certificates in their databases and certificate indices.

(The preceding discussion should not be viewed in a restrictive manner. In particular the present invention does not require use of a CA infrastructure. For example, instead of a CRL listing, a vendor or manufacturer maintains his own listing of the authorized public keys to be used, either with or without the use of any standardized certificate format. The public keys correspond to private keys, e.g., used in the manufacturing of items like identification documents and limited-series objects. The vendor or manufacturer can update a listing, and perhaps even publish the listing, to reflect those public/private keys that become untrustworthy. For example, a private key may correspond to fabrication equipment that is known to have created grey-market goods during several after-hour sessions. The list can reflect the questionable times relative to specific keys. As a further alternative, a manufacturer simply makes her public keys generally known to anyone who may want to verify the authenticity of a signature—this could be done simply by publishing the numeric values of the keys in a classified add in a newspaper (e.g., New York Times), or on a dedicated web site. Moreover, I sometimes use the term “certificate generally, e.g., to represent information associated with a private key or signing party. The information may include a public key, instructions on how to obtain a public key or how to verify the signature.)

Cryptographic Measures

Returning to Table 1, above, information to be encoded for printing in a 2-D symbology structure can be represented in terms of the type of information it conveys. For example, the information can be represented as data fields. Such data fields are preferably augmented to include a cryptographic measure (“Crypto. Measure”) as shown below in Table 2.

TABLE 2

| | | | | |
|---|---|---|---|---|
| Issuer | ID Number | Name | Birth Date | Crypto. Measure |

The original data fields preferably remain “open.” That is, the data representing the first four fields is not encrypted and remain accessible without needing decryption. (Thus the term “open cryptography” is used to describe some of my techniques.). In a first implementation, the cryptographic measure includes a hash (or reduced-bit representation) of the first four data fields. A hash algorithm “H( )” receives the field data “i” (e.g., in binary form) as input and computes a reduced-bit or condensed representation of the field data (or creates an output “O”), so that:
H(i)=O (1)

Examples of hash algorithms include, e.g., SHA-1, RIPEMD-160 and MD5, to name but a very few of the suitable hashing algorithms that can be used with the present invention. Once generated the hash is encrypted with a “private key.” The private key is held in secret. The encrypted hash constitutes a “digital signature.” The digital signature can be attached or associated with a digital certificate, which identifies a signing party. The certificate itself can be a simple collection of information to which a digital signature is attached. If desired, however, a third-party authority—or a tightly regulated data repository—may be used to provide a certificate. The public key (embedded or included in certificate information) cooperates with a digital signature to form a cryptographic measure. (In some implementations, the cryptographic measure includes only a digital signature and verification key, without a certificate. The verification key may be used to identify or find a public key, or may directly include a public key.)

The data fields including the cryptographic measure are optionally error correction coded, perhaps as a step in encoding the data fields for a particular symbology. Some examples include BCH, convolution, Reed Solomon and turbo codes. In addition to error correction coding, a 2-D symbology generator and reader may also use a Cyclic Redundancy Check (CRC) to facilitate detection of errors in decoded message data. Error correction coding will help to ensure that the original data fields can be verified, despite noise introduced, e.g., when coding, printing and scanning the data.

The field data including a cryptographic measure is passed to a 2-D symbology generator (e.g., PDF417 generator). The generator converts the field data into a 2-D symbology, which is printed on an identification document surface.

While this discussion focuses on 2-D symbologies (e.g., PDF417, data glyphs, Data Matrix, and MaxiCode etc.) the techniques disclosed herein are also applicable to other types of machine-readable indicia like digital watermarks and magnetic stripes, e.g., see assignee's U.S. Pat. Nos. 6,122,403, 6,449,377 and 6,614,914, and PCT patent application PCT/US02/20832 (published as WO 03/005291), which are each herein incorporated by reference for further watermarking details. (Instead of a machine-readable format, e.g., PDF417 or digital watermark, data including a cryptographic measure is printed or carried on an identification document. An operator forwards (e.g., audibly reads) the data, including the digits of the cryptographic measure, e.g., over a telephone to a remote operator/computer. The remote computer includes hardware and/or software to verify the forwarded information. The verification includes a cryptographic check on the data/cryptographic measure. While this may be somewhat of a tedious approach, it provides a practical solution to remote field agents that do not have a verification device. This approach also allows for a tight restriction of cryptographic keys, which may be beneficial in a “symmetrical” key system discussed below.)

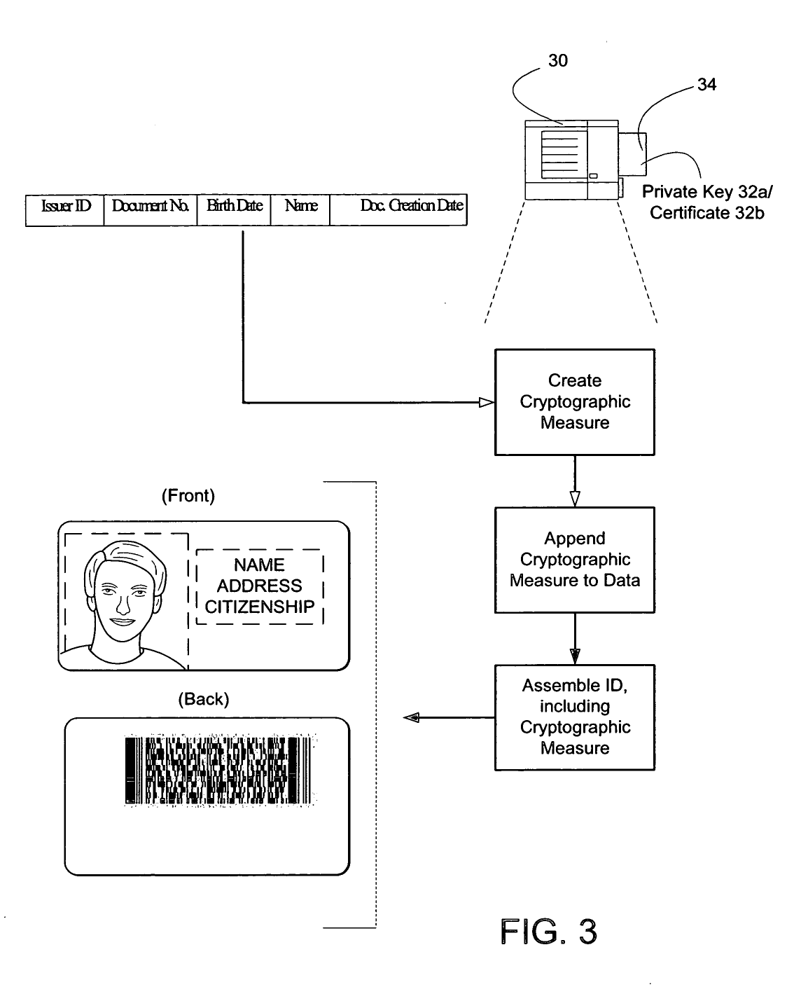

One aspect of the present invention is a secure method of forensically tracking fabrication details of an identification document including open cryptographic measures. The phrase “fabrication details” is broadly defined to include, e.g., equipment used in document fabrication, a fabrication operator, a workstation, a distribution channel, inventory details, and a fabrication completion date. These details preferably provide more than just, e.g., an issuing office by identifying particular equipment, operators, workstation, etc. A “record of fabrication” is used interchangeably with “fabrication details.”) Now consider the system illustrated with reference to FIG. 3.

An identification document is assembled in an over-the-counter (OTC) environment. An identification document assembler 30 includes a private key 32a and certificate 32b. The assembler operates to assemble identification documents. The private key 32a and certificate 32b can be stored in assembler 30 memory, can be accessed via a network connection to a secure repository, or can be stored and provided by a so-called secure token 34. (A less formal term for a token is a “dongle.”) Advantages of a secure token 34 include that the assembler's 30 credentials, such as private keys and passwords, are stored inside a protected environment of the token itself (e.g., within an encased smart card chip). The assembler's 30 private key 32a preferably never leaves the token. An example of a suitable secure token includes Aladdin's (headquartered at 15 Beit Oved Street, Tel Aviv, Israel) “eToken Pro 32k.” Of course, there are many other secure tokens that can be suitably interchanged with this aspect of the invention. And instead of a hardware-based token, a secure software solution, like OpenSSL's cryptographic library and Microsoft's CryptoAPI, can be used to provide and safeguard private keys. Regardless of the technique used, manufacturing or operational personnel preferably do not know, and cannot obtain, the assembler's private key.

Private key 32a is uniquely associated with assembler 30. Thus, fabrication details (e.g., which equipment was used to make an identification document) are readily obtained from a cryptographic measure (e.g., a certificate and digital signature) associated with a document and its fabrication details. The cryptographic measure or fabrication details can be further compared against information (e.g., a CRL) indicating unauthorized issuance.

Returning to FIG. 3, assembler 30 receives variable information as input. For example, the variable information can be machine-sensed (e.g., OCR-input from a document application or barcode), manually keyed in, accessed from a data record, etc. The variable information is formatted into data fields and may, optionally, include fixed information (e.g., identification document issuer, etc.). Example data fields are show in Table 3.

TABLE 3

| | | | | |
|---|---|---|---|---|
| Issuer ID | Document No. | Birth Date | Name | Document Creation Date |

The assembler 30 (e.g., via a secure token 34) creates a digital signature over some or all of the data fields, and appends the data fields with a cryptographic measure including at least the signature (Table 4). Since some secure tokens provide a digital certificate, the digital certificate can be included in the cryptographic measure as well. (A Certificate Authority (CA) can manage digital certificates. Or, if using a protocol like PKI X.509, the certificate may be self-signed, eliminating the role of a separate or third party CA.).

The data fields (except for the cryptographic measure) preferably remain open or unencrypted. A 2D-symbology generator processes the Table 4 data fields for conversion to an applicable format (e.g., 2D barcode). The symbology is printed on an identification document surface, and then, perhaps over-laminated, both accomplished by the assembler 30.

TABLE 4

| | | | | | |
|---|---|---|---|---|---|
| | | | | Document | |
| | Document | | | Creation | Cryptographic |
| Issuer ID | No. | Birth Date | Name | Date | Measure |

There may be many (e.g., hundreds or thousands) such OTC assemblers. Each assembler preferably includes a unique private key and unique certificate or public key. A unique private key and certificate will allow forensic tracking of an identification document back to an assembler or operator that fabricated the document. For example, since a public key is known to be associated with an assembler/operator etc., successfully decoding with the public key reveals which assembler was used during document fabrication. The cryptographic measure provides a record of fabrication for the identification document.

Consider the following advantageous applications.

Using a portable scanning device, a police officer optically scans the 2D-symbology printed on the identification document. The scanning device includes or communicates with a complete listing of authorized certificates associated with a set of authorized document assemblers. The list of certificates may have low security requirements; for example, alteration of or deleting a certificate in the list may result in “false warnings” about certain valid IDs, but will not result in missed warnings about any IDs. The scanning device (or a computer cooperating with the scanning device) verifies the authenticity of the certificate. A part of this certificate verification process may include checking a CRL (Certificate Revocation List) that is sent to or accessible by the scanning device. The CRL includes a list of certificates for specific “suspect or untrusted” assemblers, and the times that the assemblers may have been used without authorization. Thus, if a signature matches a certificate for a CRL-listed assembler, and corresponds to a time period when the station was “untrusted,” then the identification document can be presumed to be unauthorized. These methods allow detection of “unauthorized issuance” of identification documents. (Of course, a verification process may also include a visual comparison between information printed on a document and information read from the 2D symbology.).

If the certificate is deemed valid, the cryptographic measure is verified. In most cases, decrypting a digital signature, re-computing a hash of the open information and successfully comparing the recomputed hash and decrypted hash, verifies the measure and provides fabrication details. If using the X.509 standard, the corresponding public key is conveyed with a digital certificate. Otherwise, the scanning device may include or communicate with a listing of public keys for the various assemblers (e.g., an assembler is identified via its certificate, and a corresponding public key is retrieved and used to decrypt the signature). The data fields are trusted when the digital signature is verified. Moreover, a particular fabrication process is identified, which will allow detection of unauthorized issuance.

Some implementations do not involve a certificate in the traditional sense. Indeed, the present invention does not require a public key to be certified by an outside authority as “belonging” to any particular party—which is what a CA (Certifying Authority) does. Instead, some implementations attach a public key in the cryptographic measure without a certificate. Other implementations include data to identify a signor, but not in official certified form. The data is used to find or link to a corresponding decryption key. (When not using a CA and CRL, a vendor or verifying agent may maintain a listing or data record to identify suspect keys.).

Feature Swapping and Feature Binding

A common fraudulent identification document attack includes so-called feature swapping. For example, 16-year old Joan artfully cuts and pastes a photograph from her driver's license onto Molly's, Joan's 22-year old sister, driver's license (a.k.a. “photo-swapping”). Joan then uses Molly's altered driver's license to enter a bar or purchase age-restricted commodities.

Feature swapping is detected by binding or associating a first document feature (e.g., 2D-barcode or digital watermark) with a second document feature (e.g., photograph, digital watermark, 1D-barcode, etc). Binding is facilitated when a hashing algorithm also considers information printed or stored on the identification document. The information may include photograph features (e.g. a hash of at least a portion of the photograph), digital watermark payload, text, 1D-barcode payload, etc. Consider the following example: A digital signature-hashing algorithm receives a reduced-bit representation of a document photograph as a hash input. The hash algorithm also receives additional information, such as open text data fields, to be included in a print structure. The reduced-bit representation of the photograph is preferably not stored as open text in the print structure; but, rather, is recomputed and then used as a hash input—along with the additional information—when verifying the digital signature. (To recalculate the hash, a scanning device captures optical scan data corresponding to the photograph. The optical scan data can be processed using the same algorithm used to determine the reduced-bit representation of the photograph. This reduced-bit representation is communicated for use by a recalculating hashing algorithm, which also uses the open text data fields, for signature verification.). The photograph and cryptographic measure as thus bound together.

Another binding example utilizes predetermined text (e.g., the document bearer's initials) to be printed on an identification document when creating a digital signature. As similar to the above example, the predetermined text is preferably not included in the open text data fields. To verify a digital signature, the predetermined text is entered into a scanning device (e.g., via OCR or manual input). The text is converted into binary data and is used—along with some or all of the open text data—by a hashing algorithm to recompute a hash. The recomputed hash is used to verify the digital signature. Altered or swapped text is evidenced when the recomputed hash does not match the hash contained in the digital signature.

Yet another example of binding two document features utilizes a digital watermark embedded in, e.g., a photograph carried by the identification document. The digital watermark includes a plural-bit payload. At least a set of the plural bits is used—along with first data—to calculate an original hash. The original hash is encrypted with a private key to form a digital signature, which is encoded and printed, along with the first data, in the form of a 2D-barcode or other symbology. The digital watermark is embedded in the photograph, which is printed on the identification document. To verify that neither the photograph nor the 2D-barcode have been swapped from another document, a scanner or a plurality of scanners machine-sense the 2D-barcode and the embedded digital watermark. The set of plural bits is recovered from the digital watermark and the first data is recovered from the 2D-barcode. The set of plural bits and the first data are feed as inputs into a corresponding hash algorithm yielding a recalculated hash. The digital signature is decoded with a public key and the resulting original hash is obtained. The recalculated hash and the original hash are compared. If they differ, the document is considered suspect or untrustworthy. (The hashes may not coincide due to photo or 2D-barcode swapping or altering the first data. In either case, however, document is considered suspect.).

An identification document may include a so-called embedded inventory number (EIN). An EIN provides a serialization mechanism for an identification document and/or for components of the document. For example, a document substrate may include a 1-D barcode or digital watermark including a serial number encoded therein. The serial number uniquely identifies the substrate, and a subsequent document manufactured to include the substrate. The EIN can be included as a hash input when creating a digital signature. Of course the hash algorithm may also receive other data as inputs, e.g., like the data shown in the above tables. To verify the signature, the EIN is machine-read (e.g., from a scan of the 1-D barcode or digital watermark) and is then used as an input component when recomputing a hash during signature verification. Using an EIN as a hash component ties the document substrate to the cryptographic measure.

The cryptographic measure may also include a secret (e.g., a PIN or password) known privately by the bearer of an identification document.

Consider Tonya who heads to her local DMV to obtain a new driver's license. Tonya successfully labors through an exam, passes her eye test, has her photograph taken, and is asked to key in a 4-digit PIN number. Tonya's PIN number is preferably shielded from the DMV operator—in fact, the PIN number can remain a secret to everyone by Tonya. A hashing algorithm uses the PIN number—along with other data like open text—as a component of a cryptographic measure for Tonya's new driver's license. The cryptographic measure is conveyed on the identification document in a manner discussed above (e.g., 2D symbology, digital watermark or magnetic stripe). To verify that Tonya is an authorized bearer of the identification document, she must present her PIN number, which can be keyed into a verification device. The PIN number is used as a hash input component when recomputing the hash during signature verification. Using a user-defined “secret” as a hash component ties a document bearer to the cryptographic measure.

A user-defined secret for a cryptographic measure has further advantages. Such techniques will enable passive, non-electronic ID documents, to be used to create so-called “e-signatures,” where a user makes a legally recognized electronic signature. In one example, an e-signature includes the cryptographic measure and a user-entered secret. In another example, a user obtains a driver's license or credit card in a manner similar to that discussed above with respect to Tonya. To e-sign another document (e.g., a mortgage note) or to execute a transaction, the user present her driver's license and enters her secret. The cryptographic measure is recovered from the license and her entered secret is compared in connection with the cryptographic measure. A valid match produces a better assurance that the user is who the driver's license says she is. Thus, such user-defined cryptographic techniques make documents even more resistant to forgery attacks, and provide a more sure technique for people to authorize payments, e.g., with their credit card PIN over the phone or internet.

Combining Keys

In some implementations an assembler operator is assigned a private key. The private key may even be associated with a user login or password that can be managed by a computer and data repository. In other cases the operator possesses a secure token including a private key. The operator's secure token can directly interface with an assembler (e.g., via a smart card reader) or indirectly interface (e.g., through software communication or network routing). The assembler uses both the operator's private key and the assembler's private key when creating a cryptographic measure. Thus, the private keys can be used to trace back to an operator and an assembler and not just to a particular assembly office. A certificate or public key is provided to authenticate the combined operator/assembler key relationship. As with the private keys discussed above, a digital signature may include a timestamp to identify the time/date associated with a digital signature. Thus, the timestamp can be used to verify whether a particular operator was indeed working at the time the digital signature was signed—a further fabrication detail.

An operator's biometric (e.g., fingerprint, iris or retina scan, voice print, hand geometry, etc.) can be used to control access to her private key. For example, a computerized watchdog software module safeguards the operator's private key. The watchdog module includes or controls the operator's private key—which the operator may not even know. The watchdog software module releases the private key for use by a document assembler (or secure token) only after the user's biometric is confirmed. The operator presents her finger (or eye, hand, voice sample, etc.) for sampling. The biometric sample is compared against a stored biometric, and if the sampled and stored biometrics match, the watchdog module releases the operator's private key. A related implementation requires an operator's biometric prior to releasing or enabling the assembler's private key for a single private key implementation.

Forensically Tracking Multiple Stations or Distribution Channels

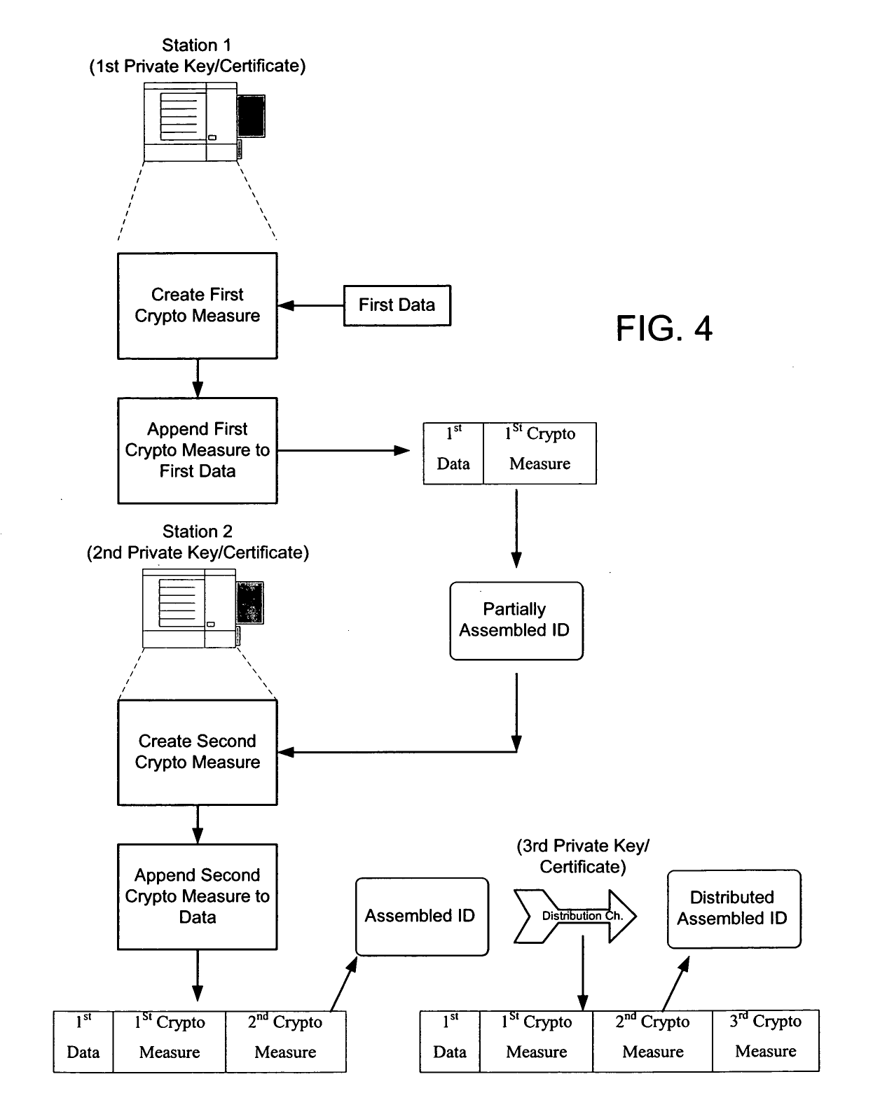

A plurality of cryptographic measures can be used to forensically track an identification document throughout an entire workflow process and distribution chain. A simplistic example is provided for illustration. Of course these techniques are readily applied to more sophisticated implementations as well. With reference to FIG. 4, a central-issue type identification document manufacturing process includes two stations—station 1 and station 2. A completed identification document is distributed through an expected distribution channel. Each station includes a corresponding private key. The private key may be provided through a secure token, as discussed above, or perhaps the private key is enabled through a biometric-watchdog software module. Regardless, a private key and certificate are associated with each of station 1 and station 2 (respectively referred to as a first private key/certificate and a second private key/certificate).

Identification document assembly is initiated at station 1. First data is gathered and a first hash is generated of the first data. The first data may correspond, e.g., to fixed or variable information, to processing time, batch or run number, document inventory management number (EIN), etc. The first hash is encrypted using the first private key to form a first cryptographic signature. The first private key is uniquely associated with station 1. The first data, the first signature and a corresponding first certificate (collectively referred to as a “first cryptographic measure” and shown in Table 5) are provided on the document. (The term “certificate” is loosely used in this section. While the certificate may contain an independent party's certification, it need not do so. A certificate may simply be a public key or information to identify a corresponding public key.) In a first implementation, the first cryptographic measure is printed, e.g., in the form of a 2D symbology or a first digital watermark, or is provided as a first magnetic stripe entry. The partially assembled document is forwarded to station 2. (Instead of printing the Table 5 information on the document, the information can be maintained in electronic form. For example, the electronic information is stored in the document's electronic circuitry, if any; or, the information is safeguarded in a secure repository, which is accessible by the various stations.

TABLE 5
First Cryptographic Measure

| | |
|---|---|
| First Data | First Cryptographic Measure |
| | (uniquely identifying Station 1) |

(As an optional and preliminary check at station 1, document components (e.g., a document substrate or core) supplied by a vendor include data and a cryptographic measure. The data and cryptographic measure are used to verify that the documents components came from an authorized vendor in an authorized manner, e.g., detecting unauthorized issuance)—allowing station 1 (or a preliminary station) to check the authenticity of the vendor's component, and not just simply determining whether the component was manufactured in the vender's facility.)

Assembly of the identification document is completed at station 2. The first cryptographic measure can be optionally verified to ensure that the partially completed identification document came from station 1 or an authorized vendor. (If printed on the partially assembled ID, the first cryptographic measure is machine-read. If stored in electronic form, the first cryptographic measure is retrieved from memory or a data repository.). A first public key that is associated with the first private key is used to verify the first cryptographic measure. If valid, the first cryptographic measure is signed using the second private key. The second private key is uniquely associated with station 2. The entire first cryptographic measure can be signed, or just a portion of the table 5 data—like the first signature—can be hashed and then encrypted using the second private key to form a second digital signature. The resulting second digital signature is appended to the first cryptographic measure, perhaps with a corresponding second certificate, to form a second cryptographic measure (Table 6). If valid, the second cryptographic measure is printed or otherwise provided on the identification document. In one implementation the second cryptographic measure is conveyed through a digital watermark. In another implementation, the second cryptographic measure is conveyed through 2-D symbology. (In the symbology implementation, the second digital signature is added to an existing print structure, without reprinting the first data and the first cryptographic measure. For example, additional symbols are added to an existing symbology structure to convey the second cryptographic measure.). Of course, the second cryptographic measure (or just the second digital signature) can be added as a magnetic stripe entry. The completed identification document is conveyed to the distribution channel.

TABLE 6
Second Cryptographic Measure

| | | |
|---|---|---|
| First | First Cryptographic Measure | Second Cryptographic Measure |
| Data | (uniquely identifying Station 1) | (uniquely identifying Station 2) |

The distribution channel includes a third private key associated therewith. The third private key is used to sign the second cryptographic measure, or to sign the entire Table 6 data, providing a record of the distribution channel. Signing the second cryptographic measure creates a third cryptographic measure. The third cryptographic measure is printed onto the identification document as a barcode, stored as a magnetic stripe entry or even stored in the secure repository. The secure repository is indexed, e.g., through the first or second digital signatures. Thus, open cryptographic measures can be used to provide verifiable record of a multi-step fabrication process.

Other Applications

The present invention finds application far beyond identification documents. For example, consider product packaging and labels. My forensic cryptographic measure can be used to uniquely identify products or product packaging, the distribution of such products or product packaging, fabrication equipment, etc. Analyzing the marked product packaging is useful to detect so-called “grey-market” products, e.g., when an authorized factory produces more of an item than their contract calls for, and then sells the additional “unauthorized” items on the grey market. Thus, grey market products are authentic, but unauthorized.

Similarly, limited-series products (e.g. like numbered prints signed by an artist, limited edition baseball cards, certificates of authentication, etc.) can be validated and traced with the above forensic cryptographic measures. Each key/certificate is uniquely associated with a fabrication process. Such limited-series products are especially attractive to forgers or unauthorized production, because part of the high value of these items is not innate in the fabrication or design, but in the fact that only a certain limited number of the items will ever be produced. (Limited-series products also include products manufactured under a limited-output license, and limited-series production scenarios include those where licensee is restricted either in a production number of such items, or in markets to which the items may be sold or distributed.)

A private key can be destroyed after signing. For example, after signing each item in a limited-series, the private key is destroyed. Destroying a private key makes it physically impossible to produce any more authenticatable items. Of course the signed limited-series items can be validated for all time using a corresponding public key, but the risk of unauthorized signing is now physically impossible, since the private key cannot mathematically be re-created or substituted.

Now consider the validation of other types of documents with security and forgery concerns, such as automobile titles. Auto titles can be physically printed with a high-quality printer, but by application of appropriate private keys, it is physically impossible, even with identical hardware, to produce a valid auto title document.

Symmetrical Key System

A symmetrical key system (e.g., where a secret key that is used to encrypt a message is the same key used to decrypt the message) can also be used to identify fabrication or production details. To illustrate, information is gathered for printing as 2D-symbology on an identification document. The gathered information is signed with a private key, and the digital signature is attached to the gathered information. The private key is unique to a particular assembler or document issuing assembly station. The digital signature is combined with a certificate including verification details. The gathered information, digital signature and certificate are encoded according to the symbology format and printed or engraved on the identification document.

To verify the document, the 2D-symbology is optically scanned and decoded. The certificate is recovered from the decoded scan data to obtain the verification details. Since a public key is unavailable, the verification details contain information (e.g., a URL or fax number) for a location (e.g., a web site) to which the decoded scan data can be forwarded for verification. The decode scan data (including at least the gathered information and digital signature) are forwarded to the location. The location includes the private key, which it uses to verify the digital signature. The location reports whether the digital signature is valid and details regarding the fabrication of the identification document.

Alternatives

Instead of an asymmetrical or symmetrical based-measure, a one-time voice recording could be used as a secure measure.

Now consider another alternative that provides a cryptographic measure including a digital signature, but does not include a certificate, public key or information associated with the public key or signor. Instead, a verification device includes a set of all authorized public keys—e.g., all public key associated with authorized fabrication equipment and/or operators. The verification device tries to decrypt the digital signature using each of the public keys until one of them works. Such a brute-force approach is feasible, e.g., even if the set includes several thousands public keys, since each of the public keys within the set of public keys can be tested within a few seconds on modern processors.

Another implementation surfaces in situations using an official or independent certificate authority (CA). An issued certificate is included in an identification document with a cryptographic measure. The cryptographic measure includes a digital signature over first data. The identification document then becomes publicly (e.g., at a bank, bar or casino) verifiable. For example, a bank obtains the first data and digital signature, and forwards (e.g., through a web site corresponding to the certificate) to the third-party CA. The CA provides a verification indication.)

Random Selection

In alternative embodiments for identifying fabrication details associated with an identification document, a serial number is randomly or pseudo-randomly selected for assignment to an identification document. (The term “serial number” is broadly used herein to include a numeric, alphanumeric or binary number and, e.g., may include a cryptographic signature.) Random or pseudo-random selection helps prevent reverse engineering which assembler or issuing station generated a particular identification document. (For example, a forger may observe documents coming off of a particular assembler, and if the assembler assigns sequential numbers to its identification document, the forger may determine a legitimate number for use with a forged document. A randomly or pseudo-randomly selected serial number is stored in a data repository with details associated with fabrication of the identification document. Such details may include, e.g., operator, issuing location, equipment used to fabricate the document, materials used to fabricate the document, security features included on the document, expected distribution channel, document issue date and lot or batch number, etc.

The serial number is provided on the identification document. For example, the serial number is conveyed with a digital watermark or barcode.

The data record is updated to include other details associated with the fabrication process or use of the document. For example, suppose that forensic investigators determine that on May 14, 2003, between the operation hours of 3-6 p.m., a particular fabrication station was used to make unauthorized identification documents. All serial numbers corresponding to that station, on that day and time, can be marked as untrustworthy. The untrusted serial numbers are placed on a list and/or the data record is updated to reflect the untrusted status. An officer or investigator, upon querying the data record and finding the untrusted status, can take appropriate remedial action (e.g., confiscate the identification document, further question the bearer of the untrusted document, etc.). Of course, instead of identifying a window of time within normal operating hours (e.g., 3-6 p.m.) as suspect, any issuance outside of normal business hours (e.g., 9 am-5 pm) may be similarly deemed suspect.

Combinations

In addition to the combinations discussed in the detailed description, examples and claims, the following are presented as even further combinations.

A1. An identification document comprising a security feature provided on the identification document, the security feature including:
first set of information corresponding to at least one of the identification document, the bearer of the identification document and an issuer of the identification document; and
a cryptographic measure associated with the first set of information, the cryptographic measure identifying at least fabrication details for the identification document.

A2. The document of A1, wherein the cryptographic measure comprises a cryptographic signature corresponding to a private key.

A3. The document of A2, wherein the private key corresponds with a public key.

A4. The document of A2, wherein the private key comprises a symmetrical key.

A5. The document of A2, wherein the cryptographic measure further comprises a public key.

A6. The document of A2, wherein the cryptographic measure further comprises a certificate issued by a certificate authority.

A7. The document of A2, wherein the cryptographic measure further comprises information identifying, but not including, a public key.

A8. A method to determine the fabrication details for the document of combination A2, wherein the identification document does not include a corresponding public key or information to obtain the public key, said method comprising:
receiving the cryptographic measure and the first set of information into a device comprising electronic processing circuitry and memory, the memory comprising a set of public keys, the public keys corresponding to at least one of fabrication equipment, operators and distribution channel;
trying to decrypt the cryptographic measure with individual keys within the set of public keys;
determining the fabrication details when a public key successfully decrypts the cryptographic measure.

A9. The document of A1, wherein the security feature is printed on the document.

A10. The document of claim A9, wherein the printing comprises at least one of a two-dimensional symbology and a digital watermark.

A11. The document of A2, wherein the cryptographic signature is over at least a portion of the first set of information and a document bearer-defined secret.

A12. The document of A11, wherein the bearer-defined secret comprises a PIN or password.

A11. The document of A2, wherein the cryptographic signature is over at least a portion of the first set of information and information corresponding to another document feature.

B1. A method of safeguarding a limited-series work comprising:
providing a cryptographic measure including an encrypted data string corresponding to a private key, wherein at least one of the private key or cryptographic measure uniquely identifies fabrication details for the work; and
providing the cryptographic measure on the limited-series work.

B2. The method of B1, further comprising destroying the private key after each work within a limited-series set of works is provided with a cryptographic measure to uniquely identify fabrication details for the respective work.

Concluding Remarks

The foregoing are just exemplary implementations of the present invention. It will be recognized that there are a great number of variations on these basic themes. The foregoing illustrates but a few applications of the detailed technology. There are many others.

The section headings in this patent document are provided merely for the reader's convenience, and provide no substantive limitations. Of course, the disclosure under one section heading may be readily combined with the disclosure under another section heading.

To provide a comprehensive disclosure without unduly lengthening this specification, each of the above-mentioned patent documents is herein incorporated by reference. The particular combinations of elements and features in the above-detailed embodiments are exemplary only; the interchanging and substitution of these teachings with other teachings in this application and the incorporated-by-reference patents/applications are also contemplated.

While the preferred implementations are illustrated with respect to an identification document the present invention is not so limited. Indeed, the inventive methods can be applied to other types of objects as well, including, but not limited to: checks, traveler checks, banknotes, legal documents, limited addition works, printed documents, in-mold designs, printed plastics, product packaging, labels, artwork, sports memorabilia and photographs.

Modern techniques are simplifying the world of manufacturing. Gone are the days when a book has to be printed in a factory or bindery. Now books and other articles are produced (e.g., printed or fabricated) “on-demand” at a point of retail distribution. Music CDs need not be stamped in a factory. Instead, a CD can be customer made (e.g., burned)—perhaps with its content assembled at the customer's choice—at the point of retail sale. These types of “OTC” manufacturing points are especially susceptible and attractive to forged or unauthorized fabrication. Accordingly the fabrication tracking techniques disclosed herein are used to similarly identify fabrication details associated with authentic OTC manufacturing points. For example, an open cryptographic measure is printed or engraved onto a disc burned for a customer at a corner record shop. The cryptographic measure uniquely identifies the individual CD burner. A similar cryptographic measure can be printed or applied to a book printed on demand.

Some of the above implementations envision hashing a complete set of data (e.g., hashing all data in Table 1 or 3) when creating a digital signature. Alternative implementations hash only a sub-set of such information. For example, if a set of information includes issuer, name, document number, issue date and birth date, the hash may only use a subset, e.g., birth date, issuer and document number, of the data fields as inputs.

A few additional details regarding digital watermarking are provided for the interested reader. Digital watermarking technology, a form of steganography, encompasses a great variety of techniques by which plural bits of digital data are hidden in some other object, preferably without leaving human-apparent evidence of alteration. Digital watermarking may be used to modify media content to embed a machine-readable code into the media content. The media may be modified such that the embedded code is imperceptible or nearly imperceptible to the user, yet may be detected through an automated detection process. Such modifications may be realized by subtle changes to the host signal. The changes can take many forms, like subtle changes to pixel values, local area luminance, transform domain characteristics (e.g., DCT coefficients), color changes, etc. Most commonly, digital watermarking is applied to media signals such as images, audio, and video signals. However, it may also be applied to other types of media, including documents (e.g., through line, word or character shifting, through texturing, graphics, or backgrounds, etc.), software, multi-dimensional graphics models, and surface textures of objects, etc. There are many processes by which media can be processed to encode a digital watermark. Some techniques employ very subtle printing, e.g., of fine lines or dots, which has the effect slightly tinting the media (e.g., a white media can be given a lightish-green cast). To the human observer the tinting appears uniform. Computer analyses of scan data from the media, however, reveals slight localized changes, permitting a multi-bit watermark payload to be discerned. Such printing can be by ink jet, dry offset, wet offset, xerography, etc. Other techniques vary the luminance or gain values in a signal to embed a message signal. The literature is full of other well-known digital watermarking techniques.

Digital watermarking systems typically have two primary components: an embedding component that embeds the watermark in the media content, and a reading component that detects and reads the embedded watermark. The embedding component embeds a watermark pattern by altering data samples of the media content or by tinting as discussed above. The reading component analyzes content to detect whether a watermark pattern is present. In applications where the watermark encodes information, the reading component extracts this information from the detected watermark.

Of course, if an identification document is for use as, e.g., a driver's license, the driver's license and information contained therein can conform to governing standards like AAMVA's “National Standard for the Driver License/Identification Card.”

The above-described methods and functionality can be facilitated with computer executable software stored on computer readable media, such as electronic memory circuits, RAM, ROM, magnetic media, optical media, memory sticks, hard disks, removable media, smart-cards etc., for execution by electronic processing circuitry. Such software may be stored and executed on a general-purpose computer, or on a server for distributed use. Instead of software, a hardware implementation, or a software-hardware implementation can be used.

In view of the wide variety of embodiments to which the principles and features discussed above can be applied, it should be apparent that the detailed embodiments are illustrative only and should not be taken as limiting the scope of the invention. Rather, I claim as my invention all such modifications as may come within the scope and spirit of the following claims and equivalents thereof.

1. An identification document comprising a photographic representation of a bearer of the identification document and indicia provided on the document, the identification document further comprising a security feature printed on a surface of the identification document in a two-dimensional symbology, the security feature including:
a first set of information corresponding to at least one of the identification document, the bearer of the identification document and an issuer of the identification document, wherein the first set of information comprises an unencrypted form; and
a cryptographic measure associated with the first set of information, the cryptographic measure identifying at least a record of fabrication for the identification document.

2. The identification document of claim 1, wherein the record of fabrication identifies at least one of equipment used in fabricating the identification document, an identification document assembler, a distribution channel and an operator of document fabrication equipment.

3. The identification document of claim 1, wherein the first set of information comprises at least one of a document identifier, issuer identification, issue date, bearer's date of birth, characteristics associated with the bearer's physical attributes, bearer's name, address, document inventory number and bearer's age.

4. The identification document of claim 1, wherein the two-dimensional symbology comprises at least one of a 2D-barcode, data glyph, maxicode, PDF 417, DataMatrix, and QR Code.

5. The identification document of claim 1, wherein the cryptographic measure comprises an encrypted form corresponding to a private key, said cryptographic measure further comprising at least one of a public key associated with the private key and information identifying where a public key associated with the private key can be obtained, wherein the private key is uniquely associated with an element of the record of fabrication.

6. The identification document of claim 1, wherein said cryptographic measure comprises a cryptographic certificate.

7. The identification document of claim 6, wherein the certificate comprises a public key for decrypting at least a portion of the cryptographic measure.

8. The identification document of claim 6, wherein the cryptographic measure comprises an encrypted form corresponding to at least a first private key and second private key, wherein the first private key is uniquely associated with a fabrication equipment operator, and the second private key is uniquely associated with equipment used in fabricating the identification document.

9. The identification document of claim 6, wherein the cryptographic measure comprises at least a first digital signature and a second digital signature, wherein the first digital signature corresponds to a first stage of a document fabrication process, and the second digital signature corresponds to a second stage of the document fabrication process.

10. The identification document of claim 6, wherein the cryptographic measure comprises a hash of at least the first set of information, the hash being encrypted by the private key.

11. The identification document of claim 10, wherein the hash further represents a second set of information, wherein the second set of information is supplemental to the first set of information.

12. The identification document of claim 11, wherein the second set of information comprises a condensed representation of the photographic representation.

13. The identification document of claim 11, wherein the second set of information comprises a document inventory number, the inventory number being conveyed by a machine-readable code carried by the identification document.

14. The identification document of claim 1, wherein the indicia comprises at least one of artwork, text, barcodes, graphics and digital watermarking.

15. A method of analyzing an identification document, the identification document comprising a first set of information and a cryptographic signature corresponding to the first set of information, wherein the first set of information and the cryptographic signature are encoded in a machine-readable format, the encoding being printed or engraved on a surface of the identification document, said method comprising:
machine-sensing the first set of information and the cryptographic signature; and
determining fabrication details of the identification document from at least the cryptographic signature.

16. The method of claim 15, wherein the machine-readable format comprises digital watermarking.

17. The method of claim 15, wherein the machine-readable format comprises a two-dimensional symbology.

18. The method of claim 15, further comprising determining whether the identification document is deemed suspect based at least on the cryptographic signature.

19. The method of claim 18, wherein the identification document further comprises a certificate corresponding to the cryptographic signature, and wherein the certificate is encoded in the machine-readable format and printed or engraved on the surface of the identification document.

20. The method of claim 19, wherein said determining comprises determining whether the certificate has been revoked.

21. The method of claim 19, wherein said cryptographic signature comprises a date indicator, and wherein said determining comprises determining whether the date indicator corresponds with an untrusted date, and wherein at least a portion of the certificate is used to determine the untrusted date.

22. The method of claim 18, wherein the cryptographic signature corresponds with a symmetrical key, and said determining step comprises communicating at least the first set of information and the cryptographic signature to a remote processor, the remote processor determining whether the identification document is suspect by at least decrypting the cryptographic signature with the symmetrical key.

23. The method of claim 18, wherein the cryptographic signature corresponds to a pair of asymmetrical keys.

24. The method of claim 18, wherein the fabrication details comprise at least one of an identification document distribution record, unauthorized issuance, type of identification document, equipment used to fabricate the document, document assembling equipment operator, document lot number and document batch number.

25. The method of claim 18, wherein the fabrication details comprise at least a type of identification document, with a unique private key corresponding to the type.

26. The method of claim 15, further comprising verifying the first set of information with the cryptographic signature.

27. A method of identifying unauthorized issuance of an identification document, wherein unauthorized issuance occurs when the identification document is fabricated on authorized equipment but is issued in an unauthorized manner, the identification document including first data and a digital signature corresponding to at least the first data, the digital signature further including a date indicator associated with the fabrication of the identification document, said method comprising:
machine-sensing the identification document to obtain the first data and the digital signature;
validating the digital signature in accordance with a certificate associated with the digital signature;
determining whether the certificate has been revoked, and if so revoked,
determining whether the date indicator corresponds with a date associated with the certificate's revocation, and if so associated,
identifying the identification document as being issued without authority.

28. The method of claim 27, wherein the identification document further includes the certificate.

29. A method to establish whether an identification document should be trusted comprising:
randomly or pseudo-randomly selecting a unique serial number;
associating the unique serial number and fabrication details in a data record;
providing the unique serial number on the identification document; and
issuing the identification document.

30. The method of claim 29, wherein the serial number is provided on the identification document in the form of a machine-readable code.

31. The method of claim 29, wherein the machine-readable code comprises at least one of a digital watermark and a 2D-symbology.

32. The method of claim 29, wherein the fabrication details comprise at least one of fabrication operator, fabrication station, equipment used in fabrication, materials used in fabrication, and fabrication completion.

33. A method of binding a first feature to a second feature, the first and second features to be provided on an identification document, said method comprising:
receiving the first feature, the first feature comprising unique characteristics;
receiving the second feature, the second feature including a first data set;
computing a cryptographic signature over the first data set and the unique characteristics;
appending the cryptographic signature and information associated with the cryptographic signature to the first data set;
printing the first feature on the identification document;
printing the second feature including the appended first data set on the identification document.

34. The method of claim 33, wherein the first feature comprises a photographic representation of a bearer of the identification document.

35. The method of claim 34, wherein the unique characteristics comprise at least one of a digital watermark embedded in the photographic representation and a hash of the photographic representation, and wherein the second feature comprises a machine-readable symbology.

36. The method of claim 35, wherein the information corresponds to at least one of a certificate, a public key and instructions on how to obtain a public key.

37. A method of identifying unauthorized issuance of an identification document, wherein unauthorized issuance occurs when the identification document is fabricated on authentic equipment, but is issued in an unauthorized manner, the identification document including first data and a digital signature corresponding to at least the first data, said method comprising:
obtaining the first data and the digital signature;
validating the digital signature in accordance with a public key associated with the digital signature; and
determining whether the public key is associated with unauthorized issuance; and if so associated,
identifying the identification document as being issued without authority.

38. The method of claim 37, wherein the digital signature further includes a date indicator associated with fabrication of the identification document, and said determining step comprises comparing the date indicator to a date associated with the unauthorized issuance.

39. The method of claim 37, comprising machine reading the first data and digital signature.

40. The method of claim 37, wherein the identification document further includes at least one of a certificate, the public key, and information to identify the public key.

41. The method of claim 37, wherein authentic equipment comprises equipment that is the same as equipment used to produce authentic documents.
